(19) United States
(12) Patent Application Publication
(10) Pub. No.: US 2025/0294453 A1
(43) Pub. Date: Sep. 18, 2025

(54) WAKE UP MECHANISM USING UWB SIDELINK AND COMPANION DEVICES

(71) Applicant: QUALCOMM Incorporated, San Diego, CA (US)

(72) Inventors: Amit BAR-OR TILLINGER, Tel-Aviv (IL); Assaf TOUBOUL, Netanya (IL); Gideon Shlomo KUTZ, Ramat Hasharon (IL); Eliyahu ARBIV, Nir Galim (IL); Michael LEVITSKY, Rehovot (IL)

(21) Appl. No.: 18/608,429

(22) Filed: Mar. 18, 2024

(51) Int. Cl. H04W 52/02; H04L 5/00; H04W 92/18

(52) U.S. Cl. CPC H04W 52/0229; H04L 5/0053; H04W 92/18

(57) ABSTRACT

A method for wireless communication at a user equipment (UE) and related apparatus are provided. In the method, the UE transmits, for a second device over a sidelink, wake up monitor information for monitoring a first wake up signal for waking up the UE based on the physical downlink control channel (PDCCH). The UE then receives, from the second device over the sidelink, a second wake up signal, where the second wake up signal is based on a reception of the first wake up signal on the second device; and performs a wake up procedure based on the second wake up signal.

### TECHNICAL FIELD

The present disclosure relates generally to communication systems and, more particularly, to the wake up mechanism using sidelink and companion devices in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a first device. The apparatus may include at least one memory and at least one processor coupled to the at least one memory. Based at least in part on information stored in the at least one memory, the at least one processor, individually or in any combination, may be configured to cause the first device to transmit, for a second device over a sidelink, wake up monitor information for monitoring a first wake up signal for waking up the first device based on physical downlink control channel (PDCCH); receive, from the second device over the sidelink, a second wake up signal, where the second wake up signal is based on a reception of the first wake up signal on the second device; and perform a wake up procedure based on the second wake up signal.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 illustrates example aspects of a sidelink slot structure.

FIG. 4 is a diagram illustrating an example of a first device and a second device that support wireless communication based on sidelink.

FIG. 5 illustrates example aspects of sidelink communication between devices, in accordance with aspects presented herein.

FIG. 6 illustrates an example of extended reality (XR) traffic flows.

FIG. 7 is a diagram illustrating example sidelink communication between a UE and its companion devices.

FIG. 8A is a call flow diagram illustrating a method of wireless communication in accordance with various aspects of the present disclosure.

FIG. 8B is a call flow diagram illustrating a method of wireless communication in accordance with various aspects of the present disclosure.

FIG. 9 is a flowchart illustrating methods of wireless communication at a first device in accordance with various aspects of the present disclosure.

FIG. 10 is a diagram illustrating an example of a hardware implementation for an example apparatus and/or UE.

FIG. 11 is a diagram illustrating an example of a hardware implementation for an example network entity.

### DETAILED DESCRIPTION

User equipment (UE) may be woke up (e.g., transitioning from a low-power state to an active state, allowing it to receive and transmit data) by a wake up signal sent by the network via the physical downlink control channel (PDCCH). However, continuously monitoring PDCCH for the wake up signal consumes significant power and time, impacting the UE's battery life and the overall user experience. The sidelink, such as ultra-wideband (UWB) sidelink, allows a UE to communicate with its companion devices, such as smart watches or extended reality (XR) goggles, with low power consumption. Example aspects presented herein provide a wake up mechanism based on sidelink communication that significantly reduces power consumption while providing reliable and low-latency communication.

Various aspects relate generally to wireless communication. Some aspects more specifically relate to the wake up mechanism using sidelink and companion devices. In some examples, a first device may transmit, for a second device over a sidelink, wake up monitor information for monitoring a first wake up signal for waking up the first device based on the physical downlink control channel (PDCCH). The first device may further receive, from the second device over the sidelink, a second wake up signal. The second wake up signal may be based on the reception of the first wake up signal on the second device. Then, the first device may perform the wake up procedure based on the second wake up signal. In some examples, the first device may be a user equipment (UE), and the second device is a companion device of the UE. In some examples, the second device may be a UE, and the first device may be a companion device of the UE. In some examples, the first device may be a first companion device of a UE, and the second device may be a second companion device of the UE. In some examples, the first device may select the second device from a plurality of candidate devices to monitor the first wake up signal based on the battery condition of each candidate device of the plurality of candidate devices.

Particular aspects of the subject matter described in this disclosure can be implemented to realize one or more of the following potential advantages. In some examples, by offloading the task of PDCCH monitoring to a single device within a closely located group (or cluster) of devices and using a sidelink (e.g., UWB sidelink) for low-power, low-latency communication of the wake up signal, the described techniques minimize the power consumption for the wake up procedure. In some examples, by allowing the selection of the most suitable device in the group (or cluster) of devices for wake up signal monitoring based on current conditions, such as battery life, the described techniques ensure reliable wake up signal detection and transmission and optimal power use across all devices.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

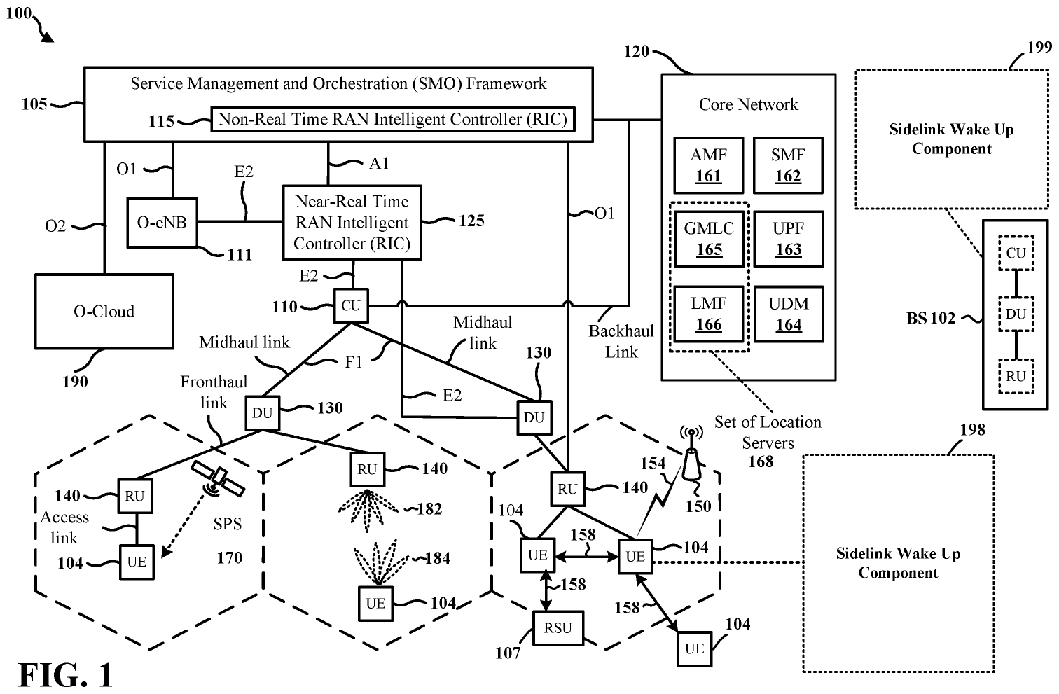

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other directly using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

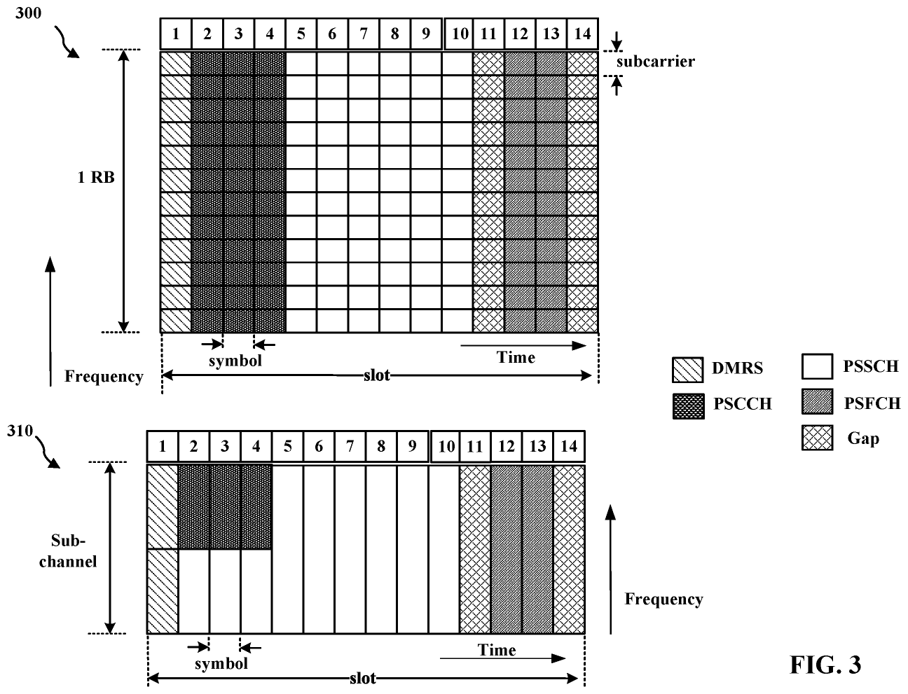

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 3, in some aspects. Although the following description, including the example slot structure of FIG. 3, may provide examples for sidelink communication in connection with 5G NR, the concepts described herein may be applicable to other similar areas, such as LTE, LTE-A, CDMA, GSM, and other wireless technologies.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a sidelink wake up component 198. The sidelink wake up component 198 may be configured to transmit, for a second device over a sidelink, wake up monitor information for monitoring a first wake up signal for waking up the UE 104 based on PDCCH; receive, from the second device over the sidelink, a second wake up signal, where the second wake up signal is based on a reception of the first wake up signal on the second device; and perform a wake up procedure based on the second wake up signal. Although the following description may be focused on 5G NR, the concepts described herein may be applicable to other similar areas, such as LTE, LTE-A, CDMA, GSM, and other wireless technologies.

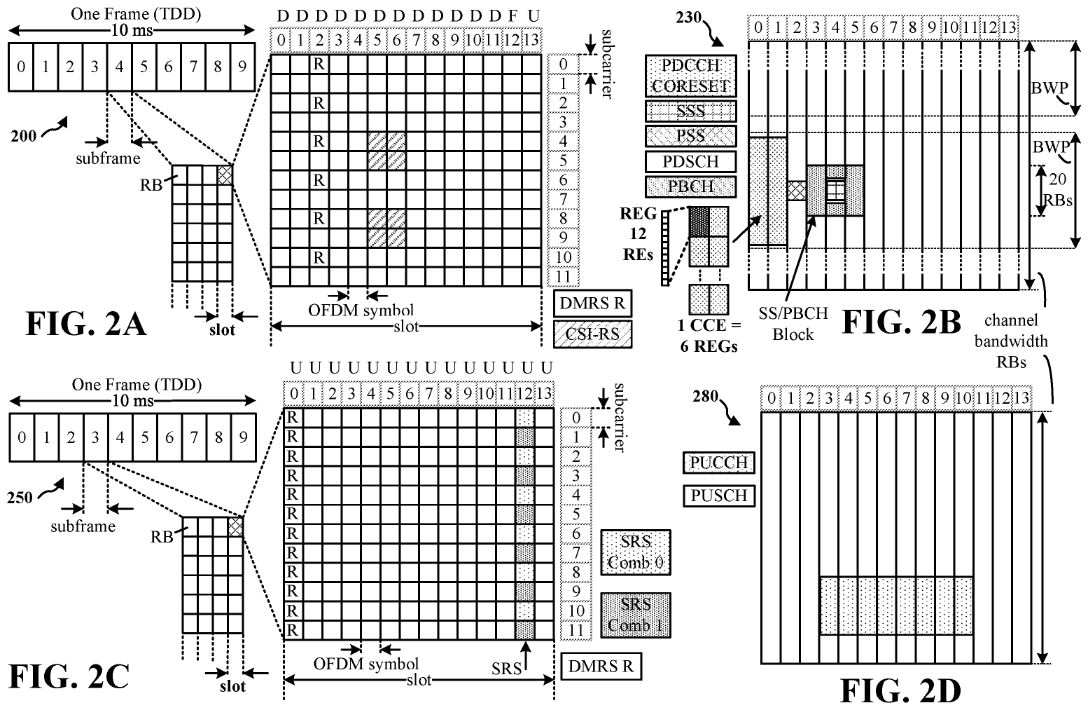

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and Fis flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

FIG. 3 includes diagrams 300 and 310 illustrating example aspects of slot structures that may be used for sidelink communication (e.g., between UEs 104, RSU, etc.). The slot structure may be within, or may use aspects of, a 5G/NR frame structure in some examples. In other examples, the slot structure may be within an LTE frame structure. As an example, CV2X communication may use an LTE frame structure, in some aspects. Although the following description may be focused on 5G NR, the concepts described herein may be applicable to other similar areas, such as LTE, LTE-A, CDMA, GSM, and other wireless technologies. The example slot structure in FIG. 3 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 300 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 310 in FIG. 3 illustrates an example in which the PSCCH occupies about 50% of a subchannel, as one example to illustrate the concept of PSCCH occupying a portion of a subchannel. The physical sidelink shared channel (PSSCH) occupies at least one subchannel. In some aspects, the PSCCH may include a first portion of sidelink control information (SCI) that may be referred to as SCI-I, and the PSSCH may include a second portion of SCI that may be referred to as SCI-2. The SCI may indicate information for a receiver to receive a data transmission in PSSCH. In some aspects, the SCI may indicate the resources on which the PSSCH will be transmitted. In such aspects, the SCI may be referred to as including a resource reservation.

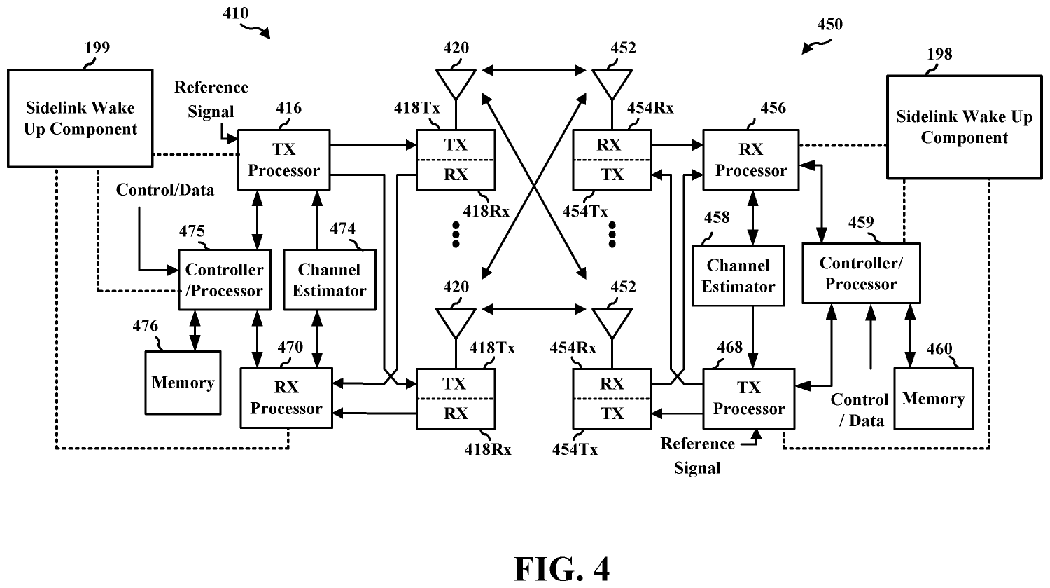

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 3, some of the REs may include control information in PSCCH and some REs may include demodulation RS (DMRS). At least one symbol may be used for feedback. FIG. 3 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 3. Multiple slots may be aggregated together in some aspects. FIG. 4 is a block diagram that illustrates an example of a first wireless device that is configured to exchange wireless communication with a second wireless device. In the illustrated example of FIG. 4, the first wireless device may include a network node such as base station 410, one or more components of a disaggregated base station, or an NTN node such as a satellite based node. The second wireless device may include a UE 450. In an example in which the second wireless device is a base station, the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the sidelink wake up component 198 of FIG. 1.

At least one of the TX processor 416, the RX processor 470, and the controller/processor 475 may be configured to perform aspects in connection with the sidelink wake up component 199 of FIG. 1.

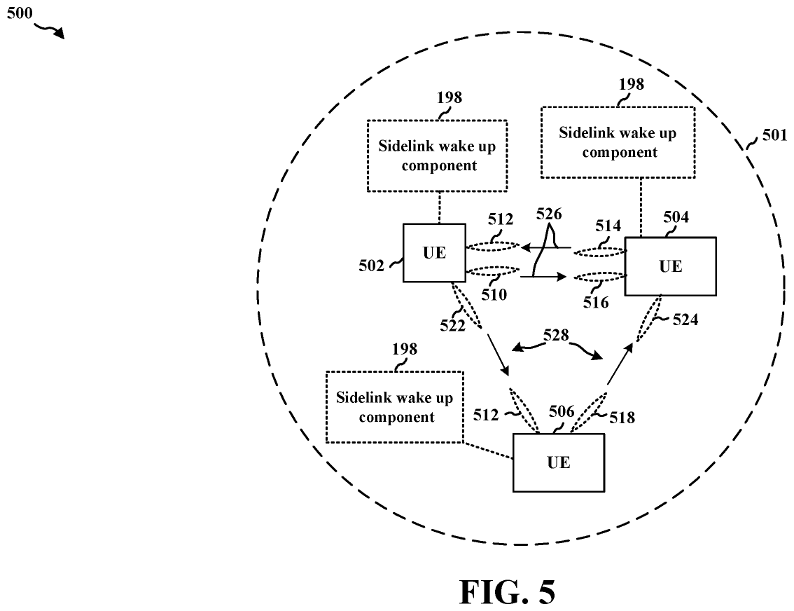

FIG. 5 illustrates an example 500 of sidelink communication between UEs 502, 504, and 506. The communication may be based on a slot structure including aspects described in connection with FIG. 3. For example, the UE 502 may transmit a sidelink transmission, e.g., including a control channel (e.g., PSCCH) and/or a corresponding data channel (e.g., PSSCH), that may be received by UEs 504 and/or 506. A control channel may include information (e.g., SCI) for decoding the data transmission (e.g., PSSCH) including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs 502, 504, and 506 may each be capable of sidelink transmission in addition to sidelink reception. The sidelink transmissions may be unicast, broadcast or multicast to nearby devices. For example, UE 502 may transmit communication intended for receipt by other UEs within a range 501 of UE 502. Additionally, or alternatively, the UE 504 or UE 506 may transmit sidelink transmissions. The sidelink transmissions, as well as other types of wireless transmissions, may be transmitted as directional beams, e.g., as described in connection with 182 and 184 in FIG. 1. For example, FIG. 5 illustrates an example in which the UE 502 transmits using beams 510 and 522 and receives via a beam 512. The UE 504 transmits using beam 514 and receives using beams 516 and 524. The UE 506 transmits using beam 518 and receives using beam 512. One or more of the UEs 502, 504, and 506 may include a sidelink wake up component 198 as described in connection with FIG. 1. In some aspects, a UE exchanging sidelink communication may be associated with, included in, or located at a vehicle.

In some aspects, sidelink communication may be based on half-duplex communication, where the UEs 502, 504, 506 transmit and receive at different times, e.g., without simultaneous transmission and reception. In some aspects one or more of the UEs 502, 504, 506 may support full-duplex communication, e.g. in which the UE transmits and receives simultaneously (e.g., overlapping at least partially in time) and in a same frequency range. Full-duplex communication may enable more efficient resource utilization and reduce latency for communication. In such an example, the links 526 may be full-duplex links between the UE 502 and the UE 504. The links 528 may be full-duplex links for the UE 506.

Sidelink communication may be based on different types or modes of resource allocation mechanisms. In a first resource allocation mode (which may be referred to herein as “Mode 1”), centralized resource allocation may be provided by a network entity. For example, a base station 102 may determine resources for sidelink communication and may allocate resources to different UEs 104 (e.g., UE 502, 504, or 506) to use for sidelink transmissions. In this first mode, a UE receives the allocation of sidelink resources from the base station 102. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field included in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

For sidelink transmissions, the resources may be included in a sidelink resource pool, for example. The resource allocation for each UE may be in units of one or more sub-channels in the frequency domain (e.g., sub-channels SC1 to SC4), and may be based on one slot in the time domain. The UE may also use resources in the current slot to perform an initial transmission, and may reserve resources in future slots for retransmissions. In this example, two different future slots are being reserved by UE1 and UE2 for retransmissions. The resource reservation may be limited to a window of a pre-defined slots and sub-channels, such as an 8 time slots by 4 sub-channels window as one non-limiting example 500, which provides 32 available resource blocks in total. This window may also be referred to as a resource selection window.

Wireless communication systems may support various types of traffic. As an example of a type of traffic that may be supported by a wireless network, XR traffic may refer to wireless communications for technologies such as virtual reality (VR), mixed reality (MR), and augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In some examples, an AR system may overlay sensory information (e.g., images) onto a natural environment and/or mask real objects from the natural environment. XR traffic may include video data and/or audio data. XR traffic may be transmitted by a base station and received by a UE, or the XR traffic may be transmitted by a UE and received by a base station.

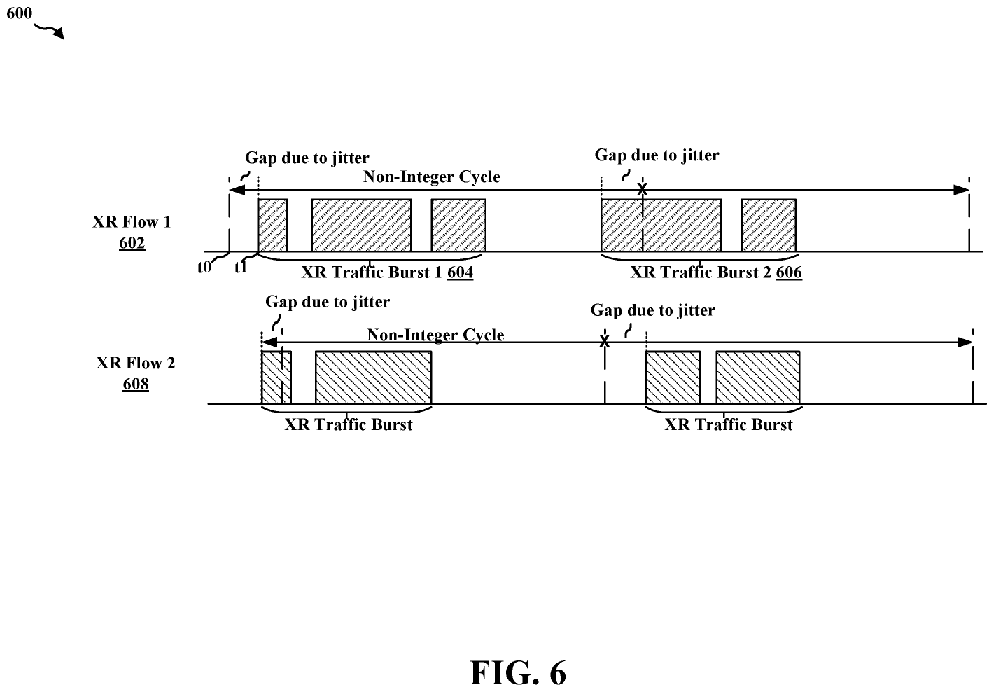

XR traffic may arrive in periodic traffic bursts (“XR traffic bursts” or “XR bursts”). An XR traffic burst may vary in a number of packets per burst and/or the size of each pack in the burst. The diagram 600 in FIG. 6 illustrates a first XR flow 602 that includes a first XR traffic burst 604 and a second XR traffic burst 606. As illustrated in the diagram 600, the traffic bursts may include different numbers of packets. For example, the first XR traffic burst 604 is shown with three packets (represented as rectangles in the diagram 600) and the second XR traffic burst 606 is shown with two packets. Furthermore, as illustrated in the diagram 600, the three packets in the first XR traffic burst 604 and the two packets in the second XR traffic burst 606 may vary in size. That is, packets within the first XR traffic burst 604 and the second XR traffic burst 606 may include varying amounts of data.

XR traffic bursts may arrive at non-integer periods (i.e., in a non-integer cycle). The periods may differ from an integer number of symbols, slots, etc. In one example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than the time at which a UE (or a base station) expects the XR traffic bursts. The variability of the packet arrival relative to the period (e.g., 16.76 ms period, 8.33 ms period, etc.) may be referred to as “jitter.” In one example, jitter for XR traffic may range from −4 ms (earlier than expected arrival) to +4 ms (later than expected arrival). For instance, referring to the first XR flow 602, a UE may expect a first packet of the first XR traffic burst 604 to arrive at time to, but the first packet of the first XR traffic burst 604 arrives at time t1.

XR traffic may include multiple flows that arrive at a UE (or a base station) concurrently with one another (or within a threshold period of time). For instance, the diagram 600 includes a second XR flow 608. The second XR flow 608 may have different characteristics than the first XR flow 602. For instance, the second XR flow 608 may have XR traffic bursts with different numbers of packets, different sizes of packets, etc. In one example, the first XR flow 602 may include video data, and the second XR flow 608 may include audio data for the video data. In another example, the first XR flow 602 may include intra-coded picture frames (I-frames) that include complete images, and the second XR flow 608 may include predicted picture frames (P-frames) that include changes from a previous image.

Example aspects presented herein provide a wake up mechanism based on communication between a UE and its surrounding companion devices (e.g., smart watches or XR goggles) via sidelinks (e.g., UWB sidelinks). By sharing the PDCCH monitoring parameters among the UE and its companion devices, the wake up mechanism allows one device to monitor the interface with the network (e.g., universal mobile telecommunications system (UMTS) terrestrial radio access network (UTRAN)-UE interface, or Uu interface) for wake up signals (WUS) and wake up another device on the sidelink (e.g., UWB sidelink) if a WUS for the corresponding device is received.

XR technology may include challenges between the computational demands of XR applications and the physical constraints, such as weight, power, and head dissipation, of XR devices. XR applications may involve substantial processing power to deliver an optimal user experience, such as high frame rates (e.g., fps≥120 Hz) and superior video formats (e.g., 8K). However, the portability and compact nature of XR devices can prioritize lower weight, lower power consumption and/or heat dissipation capabilities. It can be challenging to balance such computational abilities with lower weight, lower power consumption, and reduced heat dissipation. In some aspects, an approach can be used to shift some processing (e.g., such as some of the XR-related processing tasks) to a companion device to reduce the processing load on the XR devices.

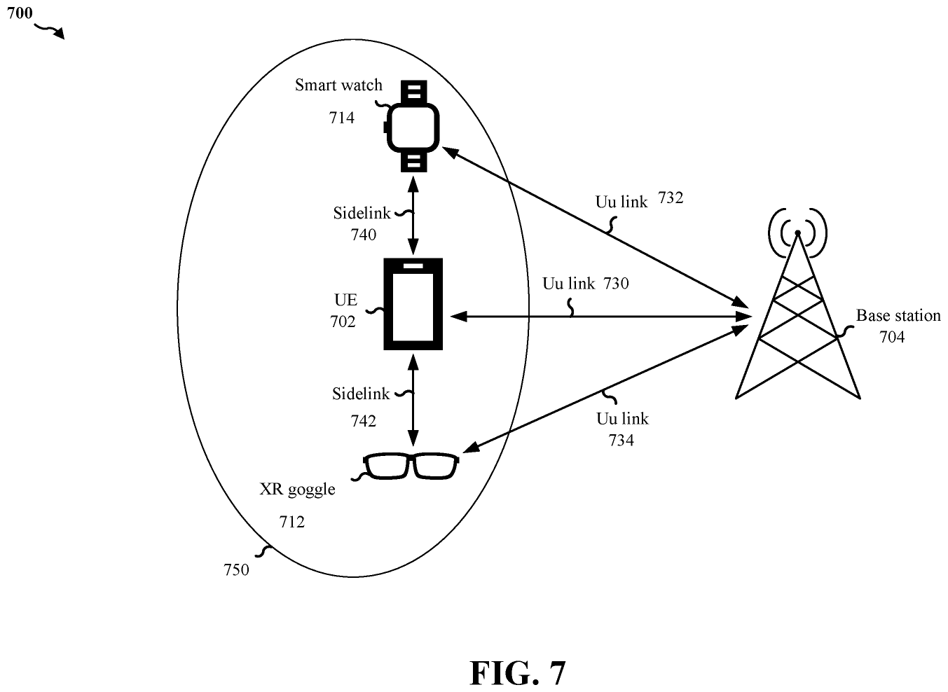

In some examples, sidelink communication may include unlicensed ultra-wideband (UWB) compliant sidelink for communication between a UE and its companion devices. FIG. 7 is a diagram 700 illustrating example sidelink communication between a UE and XR goggle 712 and a smart watch 714 as examples of companion devices. In FIG. 7, the UE 702 may communicate with its companion devices, such as XR goggle 712 and smart watch 714 via a sidelink, such as sidelinks 740, 742. In some examples, the sidelink communication may be UWB sidelink communication. The UE 702 may communicate with the base station 704 via a Uu link 730. In some examples, the companion devices may communicate with the base station 704 via the Uu link. For example, XR goggle 712 may communicate with the base station 704 via Uu link 734, and smart watch 714 may communicate with the base station 704 via Uu link 732. In some aspects the companion devices may communicate with the base station 704 via the UE using UWB sidelink communication. The UWB sidelinks may be beneficial for XR applications, as the companion devices (e.g., XR goggle 712, smart watch 714) may offload a portion of their computational tasks and their Uu communication with the network (e.g., base station 704) to a nearby UE (e.g., UE 702) through the UWB sidelinks. This offloading mechanism can significantly reduce the power consumption of the companion devices (e.g., XR goggle 712, smart watch 714) due to the task offloading and the UWB sidelink's low power consumption.

The sidelink (e.g., the sidelink 740, 742) between the UE (e.g., UE 702) and its companion devices (e.g., XR goggle 712, smart watch 714) may be used to improve the efficiency in the UEs' wake up process. Example aspects provide a wake up mechanism based on a sidelink (e.g., UWB sidelink) and companion devices. In wireless communication, companion devices of a UE, such as XR goggle 712 and smart watch 714, may be equipped with radio frequency (RF) chains that enable them to communicate directly with the network (e.g., base station 704) over Uu frequencies (e.g., via Uu link 732, 734). Given their close proximity to the UE and each other (e.g., often just a few meters apart), communication between these devices over the sidelink (e.g., the UWB sidelink) may be performed with lower power consumption and latency. Hence, the wake up mechanism for the UE (e.g., UE 702) or a companion device (e.g., XR goggle 712 and smart watch 714) may be improved by utilizing the sidelink communication with other companion devices. For example, the wake up mechanisms may consolidate the task of PDCCH monitoring of a group (or cluster) of devices to a single device in this group (or cluster), either a UE (e.g., UE 702) or a companion device (e.g., XR goggle 712). Upon detecting a relevant PDCCH, this device may initiate a low-power wake up procedure via the sidelink (e.g., a UWB sidelink). This wake up mechanism not only simplifies the wake up process but also significantly reduces the power consumption associated with it.

In some examples, a wake up signal (WUS) sent by the network (e.g., base station 704) may be based on the PDCCH. To detect the WUS, the UE's PDCCH monitoring procedure may be performed in an exhaustive manner, covering a wide search space at a low signal-to-noise ratio (SNR), and the PDCCH may carry a large payload (e.g., DCI) that can amount to hundreds of bits. The PDCCH waveform is designed to accommodate these conditions, and its detection at the receiver side (e.g., at the UE) may consume significant processing power due to the complex processes involved, including Fast Fourier Transform (FFT), Time Tracking Loop (TTL), channel estimation, demodulation, and polar channel decoding.

To improve efficiency and reduce power consumption, the task of PDCCH monitoring for a group of devices may be allocated to a single device within this group, and a sidelink mechanism is provided to wake up an appropriate device as needed. For example, referring to FIG. 7, for a group 750 of devices, including UE 702, XR goggle 712, and smart watch 714, the task of PDCCH monitoring for a group 750 of devices may be allocated to a single device (e.g., UE 702 or smart watch 714) within this group 750, and the single device may transmit the wake up signal via the sidelink (e.g., sidelink 740 or 742) to wake up an appropriate device in the group 750. The advantage of using a sidelink wake up signal lies in its simplicity and robustness. Since a small amount of payload (e.g., a few bits) is sufficient for the sidelink wake up signal to indicate which device should be awakened, the sidelink WUS waveform may be designed to be more robust to frequency and time deviations or offsets. This simplicity allows for a simple, low-power reception process that does not necessitate complex channel estimation or decoding. As an example, a basic correlation with a predefined sequence may be sufficient for the sidelink wake up purposes.

In some aspects, a companion device (e.g., smart watch 714 or XR goggle 712) may wake up the UE (e.g., UE 702) or another companion device and, in some other aspects, the UE (e.g., UE 702) may wake up the companion device (e.g., smart watch 714 or XR goggle 712). The choice between these methods depends on specific implementation factors, such as the battery capacity of the devices involved. In some examples, having the UE (e.g., UE 702) to wake up the companion device (e.g., smart watch 714 or XR goggle 712) might be more practical considering the smaller battery size of companion devices. On the other hand, in some examples, waking up the UE (e.g., UE 702) may be costlier due to a longer wake up time (compared to the wake up time of the companion devices). Hence, having a companion device to initiate the wake up procedure may be preferred when a shorter overall wake up time is desired. Either of these methods offers a substantial improvement over the wake up mechanism where each device independently monitors the WUS. Additionally, this wake up mechanism is scalable, capable of extending beyond two devices to allow a single device to monitor the WUS and wake up all other devices within a group (or cluster) of devices, optimizing power consumption and the wake up process across multiple devices. For example, in the group 750, one device, such as UE 702, may monitor the WUS for all other devices (e.g., smart watch 714 or XR goggle 712) and wake up an appropriate device when a corresponding wake up signal is received.

In some aspects, a companion device of a UE may be used to monitor the wake up signal for the UE. This approach may circumvent the complexity and the significant amount of time for the UE's modem to wake up. The companion devices may be connected to the UE via a sidelink (e.g., UWB sidelink) and may include, for example, smartwatches and XR goggles, which may have modems and wake-up procedures that are faster and consume less power compared to those of UE.

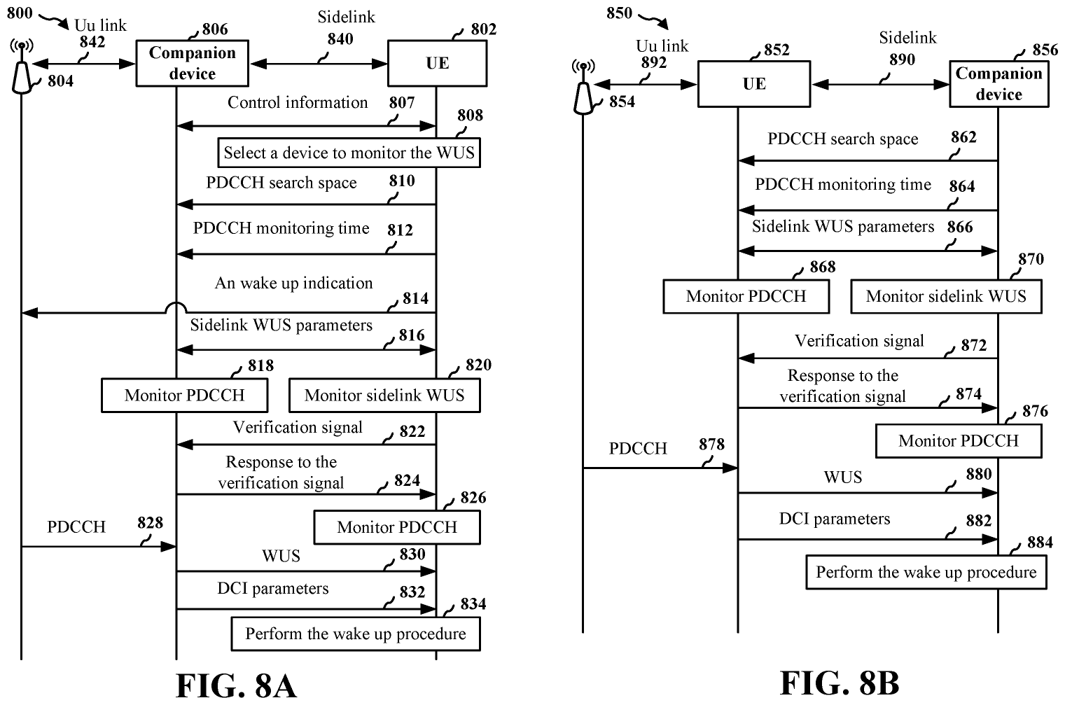

FIG. 8A is a call flow diagram 800 illustrating a method of wireless communication in accordance with various aspects of this present disclosure. Various aspects are described in connection with a UE 802, a companion device 806 of the UE 802, and a base station 804. In some examples, the companion device 806 may be smart watch 714 or XR goggle 712. The aspects may be performed by the UE 802, the companion device 806, or the base station 804 in aggregation and/or by one or more components of a base station 804 (e.g., a CU 110, a DU 130, and/or an RU 140). The companion device 806 may communicate with the base station 804 via a Uu link 842, and the companion device 806 may communicate with the UE 802 via a sidelink 840.

As shown in FIG. 8A, in some examples, the UE 802 may signal information related to the wake up procedure to the companion device 806 using a sidelink 840 (e.g., a UWB sidelink). This information may include, for example, the wake up signal (WUS) PDCCH search space parameters (e.g., at 810) and the monitoring timing for monitoring the WUS PDCCH (e.g., at 812). Additionally, the UE 802 may report, at 814 via a Uu control message (e.g., PUCCH), a wake up indication indicating the UE's reliance on the companion device 806 for wake up signals, which may potentially result in a longer wake up time. In some examples, the UE may also publish the minimum time interval between the WUS and the PDSCH downlink/uplink allocation. In some examples, the minimum time interval between the WUS and the PDSCH downlink/uplink allocation may be included in the wake up indication.

In some examples, at 816, the UE 802 and the companion device 806 may communicate the sidelink WUS parameters with each other. The sidelink WUS parameters may include, for example, sequence generation parameters, the frequency position and the time positions for the WUS. The companion device 806 is responsible for monitoring the PDCCH for wake up signaling (e.g., PDCCH WUS) at 818, and the UE 802 is responsible for monitoring the sidelink WUS at 820. Upon detecting a PDCCH wake up signal (at 828) dedicated for the UE 802, the companion device 806 may transmit, at 830, a WUS over the sidelink 840 (e.g., the UWB sidelink) to the UE 802. The companion device 806 may further transmit, at 832 the downlink control information (DCI) parameters to the UE 802 following the transmission of the WUS (at 830). At 834, the UE 802 may perform a wake up procedure based on the WUS received at 830.

In some aspects, to facilitate continuous and reliable communication, the UE 802 may regularly verify the proper working condition of the companion device 806. For example, the UE 802 may transmit a verification signal (or “keep alive” signal) at 822 via a sidelink 840 (e.g., a UWB sidelink) to ensure a companion device 806 maintains ongoing connectivity with other devices (e.g., UE 802) and may serve as the wake up source for other devices (e.g., UE 802) within close proximity. In some examples, the verification signal may be transmitted periodically following a periodicity. In some examples, each device that has a nearby device serving as its wake up signal source may send the periodic verification signals (or “keep alive” signals) to the nearby device and monitor the response from the nearby device. At 824, the companion device 806 may send a response to the verification signal to the UE 802, indicating the proper working condition of the companion device 806. In some examples, when the companion device 806 fails to respond to the verification signal (sent at 822), indicating a potential loss of connectivity or a depleted battery state, the UE 802 may revert to an independent WUS monitoring mode. For example, when the UE 802 fails to receive a proper response from the companion device 806, it may, at 826, start monitoring the PDCCH WUS from the network (e.g., base station 804) instead of relying on the companion device 806 for monitoring the wake up signal.

In some examples, the device responsible for waking up other devices may be selected dynamically from multiple candidate devices based on the current condition, such as the battery condition, of the devices involved. For example, at 807, the UE 802 and its multiple companion devices, including the companion device 806, may exchange control information regarding their conditions, such as the battery statuses. Through this collaborative communication, the UE 802 may select, at 808, a device that is in the optimal condition to monitor for the wake up signal, ensuring the most energy-efficient operation possible.

In some aspects, the UE may be responsible for waking up the companion device, as the companion device may have a smaller battery size and more limited power resources than the UE.

FIG. 8B is a call flow diagram 850 illustrating a method of wireless communication in accordance with various aspects of this present disclosure. Various aspects are described in connection with a UE 852, a companion device 856 of the UE 852, and a base station 854. In some examples, the companion device 856 may be smart watch 714 or XR goggle 712. The aspects may be performed by the UE 852, the companion device 856, or the base station 854 in aggregation and/or by one or more components of a base station 854 (e.g., a CU 110, a DU 130, and/or an RU 140). The UE 852 may communicate with the base station 854 via a Uu link 892, and the UE 852 may communicate with the companion device 856 via a sidelink 890.

As shown in FIG. 8B, in some examples, the companion device 856 may signal information related to the wake up procedure to the UE 852 using a sidelink 890 (e.g., a UWB sidelink). This information may include, for example, the wake up signal (WUS) PDCCH search space parameters (e.g., at 862) and the monitoring timing for monitoring the WUS PDCCH (e.g., at 864).

In some examples, at 866, the UE 852 and the companion device 856 may communicate the sidelink WUS parameters with each other. The sidelink WUS parameters may include, for example, sequence generation parameters, the frequency position and the time positions for the WUS. The UE 852 is responsible for monitoring the PDCCH for wake up signaling at 868, and the companion device 856 is responsible for monitoring the sidelink WUS at 870. Upon detecting a PDCCH wake up signal (at 878) dedicated for the companion device 856, the UE 852 may transmit, at 880, a WUS over the sidelink 890 (e.g., the UWB sidelink) to the companion device 856. The UE 852 may further transmit, at 882, the DCI parameters to the companion device 856 following the transmission of the WUS (at 880). At 884, the companion device 856 may perform the wake up procedure based on the WUS signal received at 880.

In some aspects, the companion device 856 may regularly verify the proper working condition of the UE 852. For example, the companion device 856 may transmit a verification signal (or “keep alive” signal) at 872 via a sidelink 890 (e.g., a UWB sidelink) to ensure a UE 852 maintains ongoing connectivity with other devices (e.g., companion device 856) and may serve as the wake up source for other devices (e.g., companion device 856) within close proximity. In some examples, the verification signal may be transmitted periodically following a periodicity. At 874, the UE 852 may send a response to the verification signal to the companion device 856, indicating the proper working condition of the UE 852. In some examples, when the UE 852 fails to respond to the verification signal (sent at 872), indicating a potential loss of connectivity or a depleted battery state, the companion device 856 may, at 876, start monitoring the PDCCH WUS from the network (e.g., base station 854) instead of relying on the UE 852 for monitoring the wake up signal.

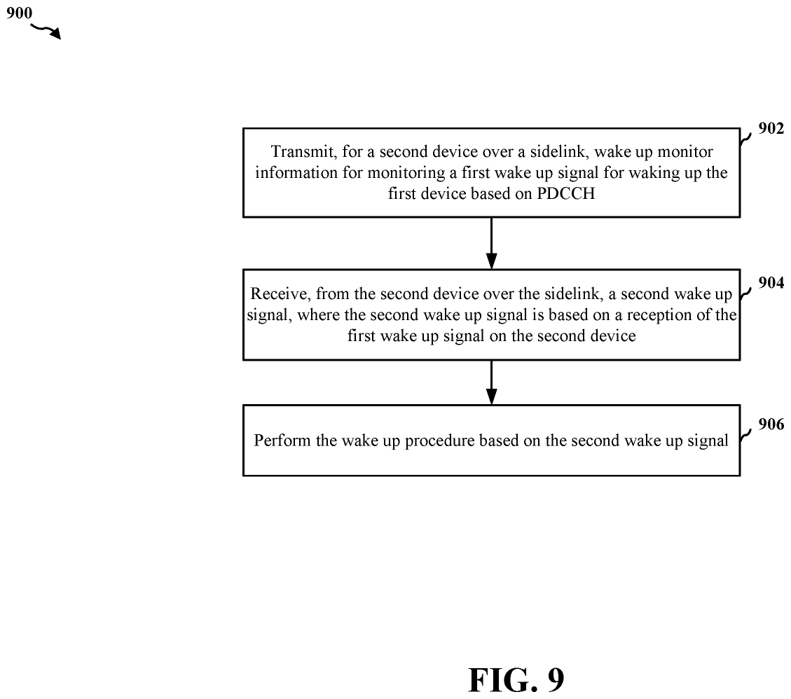

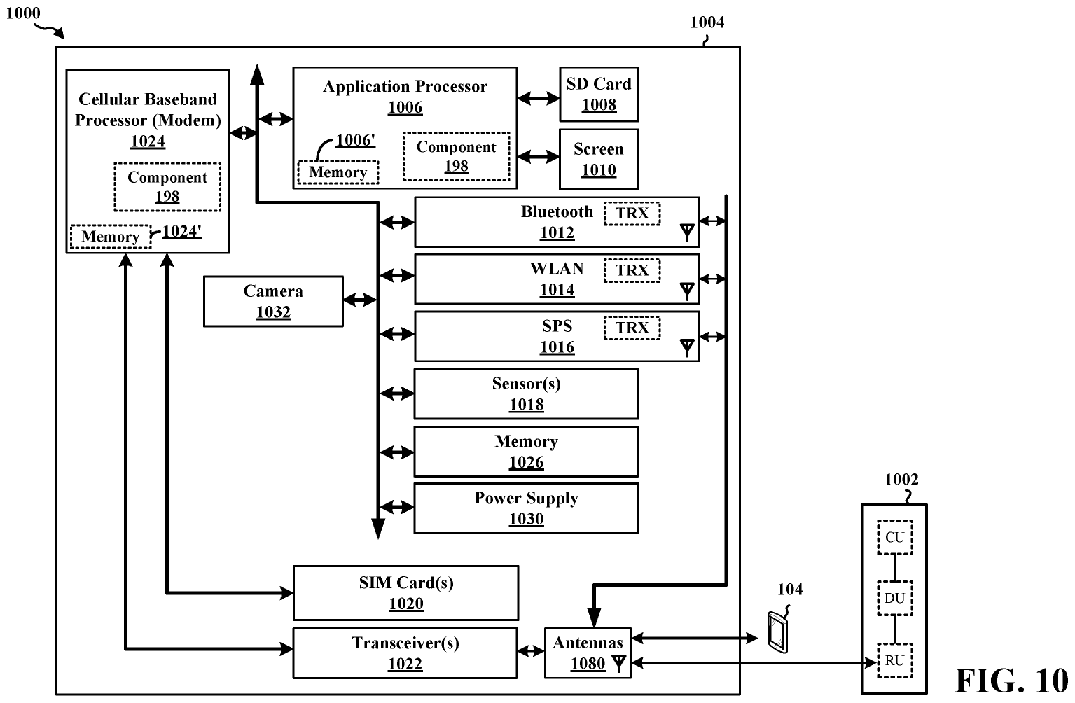

FIG. 9 is a flowchart 900 illustrating methods of wireless communication at a first device in accordance with various aspects of the present disclosure. The method may be performed by the first device. The first device may be a UE. The UE may be the UE 104, 450, 702, 802, 852, or the apparatus 1004 in the hardware implementation of FIG. 10. By offloading the task of PDCCH monitoring to a single device within a closely located group (or cluster) of devices and using a sidelink (e.g., UWB sidelink) for low-power, low-latency communication of the wake up signal, the methods minimize the power consumption for the wake up procedure. Additionally, by allowing the selection of the most suitable device in the group (or cluster) of devices for wake up signal monitoring based on current conditions, such as battery life, the methods ensure reliable wake up signal detection and transmission and optimal power use across all devices.

As shown in FIG. 9, at 902, the first device may transmit, for a second device over a sidelink, wake up monitor information for monitoring a first wake up signal for waking up the first device based on physical downlink control channel (PDCCH). FIG. 7, FIG. 8A and FIG. 8B illustrate various aspects of the steps in connection with flowchart 900. For example, referring to FIG. 8A, the first device (e.g., UE 802) may transmit, at 810 and 812, for a second device (e.g., companion device 806) over a sidelink 840, wake up monitor information for monitoring a first wake up signal (e.g., PDCCH WUS at 828) for waking up the first device (e.g., UE 802) based on physical downlink control channel (PDCCH). In some aspects, 902 may be performed by the sidelink wake up component 198.

At 904, the first device may receive, from the second device over the sidelink, a second wake up signal. The second wake up signal may be based on the reception of the first wake up signal on the second device. For example, referring to FIG. 8A, the first device (e.g., UE 802) may receive, at 830, from the second device (e.g., companion device 806) over the sidelink 840, a second wake up signal (e.g., sidelink WUS at 830). The second wake up signal may be based on the reception of the first wake up signal (e.g., PDCCH WUS at 828) on the second device (e.g., companion device 806). In some aspects, 904 may be performed by the sidelink wake up component 198.

At 906, the first device may perform a wake up procedure based on the second wake up signal. For example, referring to FIG. 8A, the first device (e.g., UE 802) may perform, at 834, a wake up procedure based on the second wake up signal (e.g., sidelink WUS at 830). In some aspects, 906 may be performed by the sidelink wake up component 198.

In some aspects, the first device may be a UE, and the second device may be a companion device of the UE. The UE may be the UE 104, 450, 702, or the apparatus 1004 in the hardware implementation of FIG. 10. For example, referring to FIG. 8A, the first device may be a UE 802, and the second device may be a companion device 806 of the UE 802.

In some aspects, the second device may be a UE, and the second device may be a companion device of the UE. For example, referring to FIG. 8B, the second device may be a UE 852, and the first device may be a companion device 856 of the UE 852.

In some aspects, the first device may be a first companion device of a UE, and the second device may be a second companion device of the UE. For example, referring to FIG. 7, the first device may be a first companion device (e.g., XR goggle 712) of a UE 702, and the second device may be a second companion (e.g., smart watch 714) device of the UE 802.

In some aspects, the sidelink may be an ultra-wide band sidelink. For example, referring to FIG. 7, FIG. 8A, and FIG. 8B, the sidelink 740, 742, 840, and 890 may be an ultra-wide band sidelink.

In some aspects, the wake up monitor information may include one or more of: search space parameters for monitoring the first wake up signal, or the monitoring timing for monitoring the first wake up signal. For example, referring to FIG. 8A, the wake up monitor information may include one or more of: search space parameters (at 810) for monitoring the first wake up signal (e.g., PDCCH WUS at 828), or the monitoring timing (at 812) for monitoring the first wake up signal (e.g., PDCCH WUS at 828).

In some aspects, the first device may transmit, for a network entity, a wake up indication of the wake up procedure based on the second wake up signal. The network entity may be a base station, or a component of a base station, in the access network of FIG. 1 or a core network component (e.g., base station 102, 804; or the network entity 1002 in the hardware implementation of FIG. 10). In some aspects, the first device may transmit the wake up indication via physical uplink control channel (PUCCH). For example, referring to FIG. 8A, the first device (e.g., UE 802) may transmit, at 814, for a network entity (base station 804), a wake up indication. The wake up indication may indicate the wake up procedure based on the second wake up signal (e.g., sidelink WUS at 830). In some examples, the wake up indication may be transmitted (at 814) via PUCCH.

In some aspects, the wake up indication may further include: the minimal time interval between the first wake up signal and a downlink or uplink allocation for communication with the network entity. For example, referring to FIG. 8A, the wake up indication (at 814) may include the minimal time interval between the first wake up signal and a downlink or uplink allocation for communication with the network entity (base station 804).

In some aspects, the first device may communicate, with the second device, sidelink wake up signal (WUS) parameters for the second wake up signal. For example, referring to FIG. 8A, the first device (e.g., UE 802) may communicate, at 816, with the second device (e.g., companion device 806), sidelink WUS parameters for the second wake up signal.

In some aspects, the sidelink WUS parameters may include one or more of: sequence generation parameters for the second wake up signal, the frequency domain position for the second wake up signal, or the time domain position for the second wake up signal. For example, referring to FIG. 8A, the sidelink WUS parameters (at 816) may include one or more of: sequence generation parameters for the second wake up signal (e.g., sidelink WUS at 830), the frequency domain position for the second wake up signal (e.g., sidelink WUS at 830), or the time domain position for the second wake up signal (e.g., sidelink WUS at 830).

In some aspects, the first device may, after receiving the second wake up signal: receive, from the second device, downlink control information (DCI) parameters. For example, referring to FIG. 8A, the first device (e.g., UE 802) may receive, at 832 from the second device (e.g., companion device 806), DCI parameters after receiving the sidelink WUS (at 830).

In some aspects, the second device may be one candidate device of a plurality of candidate devices, and the first device may select the second device from the plurality of candidate devices for monitoring the first wake up signal. For example, referring to FIG. 8A, the second device (e.g., companion device 806) may be one candidate device of a plurality of candidate devices, and the first device (e.g., UE 802) may, at 808, select the second device (e.g., companion device 806) from the plurality of candidate devices for monitoring the first wake up signal (e.g., PDCCH WUS at 828).

In some aspects, the first device may select, based on a battery condition of each candidate device of the plurality of candidate devices, the second device from the plurality of candidate devices for monitoring the first wake up signal. For example, referring to FIG. 8A, the first device (e.g., UE 802) may select, at 808, based on a battery condition of each candidate device of the plurality of candidate devices, the second device (e.g., companion device 806) from the plurality of candidate devices for monitoring the first wake up signal (e.g., PDCCH WUS at 828).

In some aspects, the first device may receive, from the plurality of candidate devices, control information for the battery condition for each candidate device of the plurality of candidate devices. For example, referring to FIG. 8A, the first device (e.g., UE 802) may receive, at 807, from the plurality of candidate devices, control information for the battery condition for each candidate device of the plurality of candidate devices.

In some aspects, the first device may transmit, for the second device over the sidelink, a verification signal to the second device; and monitor a response signal for the verification signal from the second device. For example, referring to FIG. 8A, the first device (e.g., UE 802) may transmit, for the second device (e.g., companion device 806) over the sidelink 840, a verification signal to the second device (e.g., companion device 806); and monitor a response signal (e.g., at 824) for the verification signal from the second device (e.g., companion device 806).

In some aspects, the first device may transmit the verification signal to the second device periodically based on a periodicity. For example, referring to FIG. 8A, the first device (e.g., UE 802) may transmit, at 822, the verification signal to the second device (e.g., companion device 806) periodically based on a periodicity.

In some aspects, the first device may monitor, in response to a lack of the response signal for the verification signal from the second device, the first wake up signal. For example, referring to FIG. 8A, the first device (e.g., UE 802) may monitor, at 826, in response to a lack of the response signal for the verification signal from the second device (e.g., companion device 806), the first wake up signal (e.g., PDCCH WUS).

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor (or processing circuitry) 1024 (also referred to as a modem) coupled to one or more transceivers 1022 (e.g., cellular RF transceiver). The cellular baseband processor(s) (or processing circuitry) 1024 may include at least one on-chip memory (or memory circuitry) 1024′. In some aspects, the apparatus 1004 may further include one or more subscriber identity modules (SIM) cards 1020 and at least one application processor (or processing circuitry) 1006 coupled to a secure digital (SD) card 1008 and a screen 1010. The application processor(s) (or processing circuitry) 1006 may include on-chip memory (or memory circuitry) 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) (or processing circuitry) 1024 communicates through the transceiver(s) 1022 via one or more antennas 1080 with the UE 104 and/or with an RU associated with a network entity 1002. The cellular baseband processor(s) (or processing circuitry) 1024 and the application processor(s) (or processing circuitry) 1006 may each include a computer-readable medium/memory (or memory circuitry) 1024′, 1006′, respectively. The additional memory modules 1026 may also be considered a computer-readable medium/memory (or memory circuitry). Each computer-readable medium/memory (or memory circuitry) 1024′, 1006′, 1026 may be non-transitory. The cellular baseband processor(s) (or processing circuitry) 1024 and the application processor(s) (or processing circuitry) 1006 are each responsible for general processing, including the execution of software stored on the computer-readable medium/memory (or memory circuitry). The software, when executed by the cellular baseband processor(s) (or processing circuitry) 1024/application processor(s) (or processing circuitry) 1006, causes the cellular baseband processor(s) (or processing circuitry) 1024/application processor(s) (or processing circuitry) 1006 to perform the various functions described supra. The cellular baseband processor(s) (or processing circuitry) 1024 and the application processor(s) (or processing circuitry) 1006 are configured to perform the various functions described supra based at least in part of the information stored in the memory (or memory circuitry). That is, the cellular baseband processor(s) (or processing circuitry) 1024 and the application processor(s) (or processing circuitry) 1006 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1024/application processor(s) (or processing circuitry) 1006 when executing software. The cellular baseband processor(s) (or processing circuitry) 1024/application processor(s) (or processing circuitry) 1006 may be a component of the UE 450 and may include the at least one memory 460 and/or at least one of the TX processor 468, the RX processor 456, and the controller/processor 459. In one configuration, the apparatus 1004 may be at least one processor chip (modem and/or application) and include just the cellular baseband processor(s) (or processing circuitry) 1024 and/or the application processor(s) (or processing circuitry) 1006, and in another configuration, the apparatus 1004 may be the entire UE (e.g., see UE 450 of FIG. 4) and include the additional modules of the apparatus 1004.

As discussed supra, the component 198 may be configured to transmit, for a second device over a sidelink, wake up monitor information for monitoring a first wake up signal for waking up the UE based on PDCCH; receive, from the second device over the sidelink, a second wake up signal, where the second wake up signal is based on a reception of the first wake up signal on the second device; and perform a wake up procedure based on the second wake up signal. The component 198 may be further configured to perform any of the aspects described in connection with the flowchart in FIG. 9 and/or performed by the UE 802 in FIG. 8A. The component 198 may be within the cellular baseband processor(s) (or processing circuitry) 1024, the application processor(s) (or processing circuitry) 1006, or both the cellular baseband processor(s) (or processing circuitry) 1024 and the application processor(s) (or processing circuitry) 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) (or processing circuitry) 1024 and/or the application processor(s) (or processing circuitry) 1006, includes means for transmitting, for a second device over a sidelink, wake up monitor information for monitoring a first wake up signal for waking up the UE based on PDCCH, means for receiving, from the second device over the sidelink, a second wake up signal, where the second wake up signal is based on a reception of the first wake up signal on the second device, and means for performing a wake up procedure based on the second wake up signal. The apparatus 1004 may further include means for performing any of the aspects described in connection with the flowchart in FIG. 9 and/or aspects performed by the UE 802 in FIG. 8A. The means may be the component 198 of the apparatus 1004 configured to perform the functions recited by the means. As described supra, the apparatus 1004 may include the TX processor 468, the RX processor 456, and the controller/processor 459. As such, in one configuration, the means may be the TX processor 468, the RX processor 456, and/or the controller/processor 459 configured to perform the functions recited by the means.

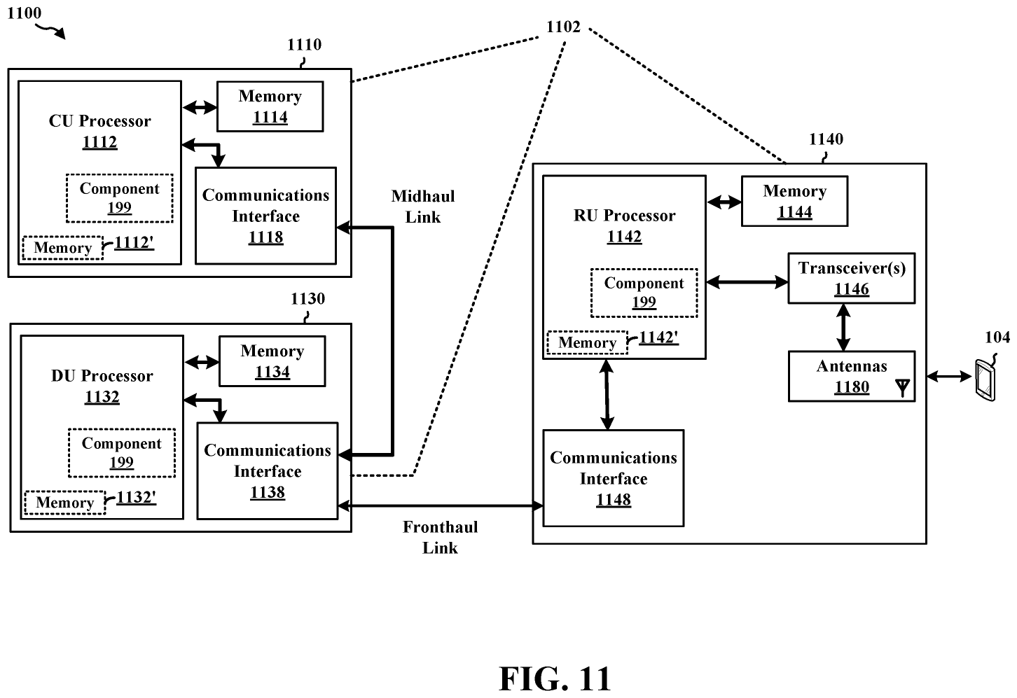

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor (or processing circuitry) 1112. The CU processor(s) (or processing circuitry) 1112 may include on-chip memory (or memory circuitry) 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor (or processing circuitry) 1132. The DU processor(s) (or processing circuitry) 1132 may include on-chip memory (or memory circuitry) 1132′. In some aspects, the DU 1130 may further include additional memory modules 1134 and a communications interface 1138. The DU 1130 communicates with the RU 1140 through a fronthaul link. The RU 1140 may include at least one RU processor (or processing circuitry) 1142. The RU processor(s) (or processing circuitry) 1142 may include on-chip memory (or memory circuitry) 1142′. In some aspects, the RU 1140 may further include additional memory modules 1144, one or more transceivers 1146, antennas 1180, and a communications interface 1148. The RU 1140 communicates with the UE 104. The on-chip memory (or memory circuitry) 1112′, 1132′, 1142′ and the additional memory modules 1114, 1134, 1144 may each be considered a computer-readable medium/memory (or memory circuitry). Each computer-readable medium/memory (or memory circuitry) may be non-transitory. Each of the processors (or processing circuitry) 1112, 1132, 1142 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to perform any of the aspects performed by the base station 804 in FIG. 8A. The component 199 may be within one or more processors (or processing circuitry) of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 includes means for performing any of the aspects performed by the base station 804 in FIG. 8A. The means may be the component 199 of the network entity 1102 configured to perform the functions recited by the means. As described supra, the network entity 1102 may include the TX processor 416, the RX processor 470, and the controller/processor 475. As such, in one configuration, the means may be the TX processor 416, the RX processor 470, and/or the controller/processor 475 configured to perform the functions recited by the means.

This disclosure provides a method for wireless communication at a first device. The method may include transmitting, for a second device over a sidelink, wake up monitor information for monitoring a first wake up signal for waking up the first device based on PDCCH; receiving, from the second device over the sidelink, a second wake up signal, where the second wake up signal is based on a reception of the first wake up signal on the second device; and performing a wake up procedure based on the second wake up signal. By offloading the task of PDCCH monitoring to a single device within a closely located group (or cluster) of devices and using a sidelink (e.g., UWB sidelink) for low-power, low-latency communication of the wake up signal, the methods minimize the power consumption for the wake up procedure. Additionally, by allowing the selection of the most suitable device in the group (or cluster) of devices for wake up signal monitoring based on current conditions, such as battery life, the methods ensure reliable wake up signal detection and transmission and optimal power use across all devices.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a first device. The method includes transmitting, for a second device over a sidelink, wake up monitor information for monitoring a first wake up signal for waking up the first device based on physical downlink control channel (PDCCH); receiving, from the second device over the sidelink, a second wake up signal, wherein the second wake up signal is based on a reception of the first wake up signal on the second device; and performing a wake up procedure based on the second wake up signal.
Aspect 2 is the method of aspect 1, wherein the first device is a user equipment (UE), and the second device is a companion device of the UE.
Aspect 3 is the method of aspect 1, wherein the second device is a user equipment (UE), and the first device is a companion device of the UE.
Aspect 4 is the method of aspect 1, wherein the first device is a first companion device of a user equipment (UE), and the second device is a second companion device of the UE.
Aspect 5 is the method of any of aspects 1 to 4, wherein the sidelink is an ultra-wide band sidelink.
Aspect 6 is the method of any of aspects 1 to 5, wherein the wake up monitor information comprises one or more of: search space parameters for monitoring the first wake up signal, or a monitoring timing for monitoring the first wake up signal.
Aspect 7 is the method of any of aspects 1 to 6, where the method further includes transmitting, for a network entity, a wake up indication of the wake up procedure based on the second wake up signal.
Aspect 8 is the method of aspect 7, wherein transmitting the wake up indication comprises: transmitting, via physical uplink control channel (PUCCH), the wake up indication.
Aspect 9 is the method of aspect 7, wherein the wake up indication further comprises: a minimal time interval between the first wake up signal and a downlink or uplink allocation for communication with the network entity.
Aspect 10 is the method of any of aspects 1 to 9, where the method further includes communicating, with the second device, sidelink wake up signal (WUS) parameters for the second wake up signal.
Aspect 11 is the method of aspect 10, wherein the sidelink WUS parameters comprise one or more of: sequence generation parameters for the second wake up signal, a frequency domain position for the second wake up signal, or a time domain position for the second wake up signal.
Aspect 12 is the method of any of aspects 1 to 11, where the method further includes, after receiving the second wake up signal: receiving, from the second device, downlink control information (DCI) parameters.
Aspect 13 is the method of aspect 1, wherein the second device is one candidate device of a plurality of candidate devices, and wherein the method further comprises: selecting the second device from the plurality of candidate devices for monitoring the first wake up signal.
Aspect 14 is the method of aspect 13, wherein selecting the second device comprises: selecting, based on a battery condition of each candidate device of the plurality of candidate devices, the second device from the plurality of candidate devices for monitoring the first wake up signal.
Aspect 15 is the method of aspect 14, where the method further includes receiving, from the plurality of candidate devices, control information for the battery condition for each candidate device of the plurality of candidate devices.
Aspect 16 is the method of any of aspects 1 to 15, where the method further includes transmitting, for the second device over the sidelink, a verification signal to the second device; and monitoring a response signal for the verification signal from the second device.
Aspect 17 is the method of aspect 16, wherein transmitting the verification signal to the second device comprises: transmitting the verification signal to the second device periodically based on a periodicity.
Aspect 18 is the method of aspect 16, where the method further includes monitoring, in response to a lack of the response signal for the verification signal from the second device, the first wake up signal.
Aspect 19 is an apparatus for wireless communication at a first device, comprising: a processing system that includes processor circuitry and memory circuitry that stores code and is coupled with the processor circuitry, the processing system configured to cause the first device to perform the method of one or more of aspects 1-18.
Aspect 20 is an apparatus for wireless communication at a first device, comprising: at least one memory; and at least one processor coupled to the at least one memory and, where the at least one processor, individually or in any combination, is configured to perform the method of any of aspects 1-18.
Aspect 21 is the apparatus for wireless communication at a first device, comprising means for performing each step in the method of any of aspects 1-18.
Aspect 22 is an apparatus of any of aspects 19-21, further comprising a transceiver configured to receive or to transmit in association with the method of any of aspects 1-18.
Aspect 23 is a computer-readable medium (e.g., a non-transitory computer-readable medium) storing computer executable code at a first device, the code when executed by at least one processor causes the at least one processor to, individually or in any combination, perform the method of any of aspects 1-18.

What is claimed is:

1. An apparatus for wireless communication at a first device, comprising:
at least one memory; and
at least one processor coupled to the at least one memory and, based at least in part on information stored in the at least one memory, the at least one processor, individually or in any combination, is configured to cause the first device to:
transmit, for a second device over a sidelink, wake up monitor information for monitoring a first wake up signal for waking up the first device based on physical downlink control channel (PDCCH);
receive, from the second device over the sidelink, a second wake up signal, wherein the second wake up signal is based on a reception of the first wake up signal on the second device; and
perform a wake up procedure based on the second wake up signal.

2. The apparatus of claim 1, further comprising a transceiver coupled to the at least one processor, wherein to transmit the wake up monitor information, the at least one processor, individually or in any combination, is configured to cause the first device to transmit the wake up monitor information via the transceiver, and wherein the first device is a user equipment (UE), and the second device is a companion device of the UE.

3. The apparatus of claim 1, wherein the second device is a user equipment (UE), and the first device is a companion device of the UE.

4. The apparatus of claim 1, wherein the first device is a first companion device of a user equipment (UE), and the second device is a second companion device of the UE.

5. The apparatus of claim 1, wherein the sidelink is an ultra-wide band sidelink.

6. The apparatus of claim 1, wherein the wake up monitor information comprises one or more of:
search space parameters for monitoring the first wake up signal, or
a monitoring timing for monitoring the first wake up signal.

7. The apparatus of claim 1, wherein the at least one processor, individually or in any combination, is further configured to cause the first device to:
transmit, for a network entity, a wake up indication of the wake up procedure based on the second wake up signal.

8. The apparatus of claim 7, wherein to transmit the wake up indication, the at least one processor, individually or in any combination, is configured to cause the first device to:
transmit, via physical uplink control channel (PUCCH), the wake up indication.

9. The apparatus of claim 7, wherein the wake up indication further comprises:
a minimal time interval between the first wake up signal and a downlink or uplink allocation for communication with the network entity.

10. The apparatus of claim 1, wherein the at least one processor, individually or in any combination, is further configured to cause the first device to:
communicate, with the second device, sidelink wake up signal (WUS) parameters for the second wake up signal.

11. The apparatus of claim 10, wherein the sidelink WUS parameters comprise one or more of:
sequence generation parameters for the second wake up signal,
a frequency domain position for the second wake up signal, or
a time domain position for the second wake up signal.

12. The apparatus of claim 1, wherein the at least one processor, individually or in any combination, is further configured to cause the first device to, after being configured to receive the second wake up signal:
receive, from the second device, downlink control information (DCI) parameters.

13. The apparatus of claim 1, wherein the second device is one candidate device of a plurality of candidate devices, and wherein the at least one processor, individually or in any combination, is further configured to cause the first device to:
select the second device from the plurality of candidate devices for monitoring the first wake up signal.

14. The apparatus of claim 13, wherein to select the second device, the at least one processor, individually or in any combination, is further configured to cause the first device to:
select, based on a battery condition of each candidate device of the plurality of candidate devices, the second device from the plurality of candidate devices for monitoring the first wake up signal.

15. The apparatus of claim 14, wherein the at least one processor, individually or in any combination, is further configured to cause the first device to:
receive, from the plurality of candidate devices, control information for the battery condition for each candidate device of the plurality of candidate devices.

16. The apparatus of claim 1, wherein the at least one processor, individually or in any combination, is further configured to cause the first device to:
transmit, for the second device over the sidelink, a verification signal to the second device; and
monitor a response signal for the verification signal from the second device.

17. The apparatus of claim 16, wherein to transmit the verification signal to the second device, the at least one processor, individually or in any combination, is configured to cause the first device to:
transmit the verification signal to the second device periodically based on a periodicity.

18. The apparatus of claim 16, wherein the at least one processor, individually or in any combination, is further configured to cause the first device to:
monitor, in response to a lack of the response signal for the verification signal from the second device, the first wake up signal.

19. A method of wireless communication at a first device, comprising:
transmitting, for a second device over a sidelink, wake up monitor information for monitoring a first wake up signal for waking up the first device based on physical downlink control channel (PDCCH);
receiving, from the second device over the sidelink, a second wake up signal, wherein the second wake up signal is based on a reception of the first wake up signal on the second device; and
performing a wake up procedure based on the second wake up signal.

20. A computer-readable medium storing computer executable code at a first device, the code when executed by at least one processor causes the at least one processor to, individually or in any combination, cause the first device to:
transmit, for a second device over a sidelink, wake up monitor information for monitoring a first wake up signal for waking up the first device based on physical downlink control channel (PDCCH);
receive, from the second device over the sidelink, a second wake up signal, wherein the second wake up signal is based on a reception of the first wake up signal on the second device; and
perform a wake up procedure based on the second wake up signal.
